(19) United States
(12) Patent Application Publication
(10) Pub. No.: US 2007/0242054 A1
(43) Pub. Date: Oct. 18, 2007

(54) Light transmission touch panel and manufacturing method thereof

(75) Inventors: Yih Chang, Jhonghe (TW); Tung-Yang Tang, Jhubei (TW); Yuang-Wei Lai, Changhua (TW); Chun-Chieh Kuo, Kaohsiung (TW); Ching-Lung Chen, Kaohsiung (TW)

Correspondence Address: OLIFF & BERRIDGE, PLC, P.O. BOX 19928, ALEXANDRIA, VA, 22320, US

(73) Assignee: RITDISPLAY CORPORATION, HSIN CHU (TW)

(21) Appl. No.: 11/783,838

(22) Filed: Apr. 12, 2007

(30) Foreign Application Priority Data
Apr. 14, 2006 (TW) 095113484

(51) Int. Cl. G06F 3/041

(52) U.S. Cl. 345/173

(57) ABSTRACT

A light transmission touch panel comprises a transparent substrate, a first transparent conductive layer, an insulation layer and a second transparent conductive layer, wherein the first transparent conductive layer, the insulation layer and the second transparent conductive layer are patterned and overlaid on a surface of the substrate. The first transparent conductive layer and the second transparent conductive layer are either on a surface or respectively on two opposite surfaces of the insulation layer. An electrical field having a component along the surface of the substrate occurs between two adjacent portions of the first transparent conductive layer and the second transparent conductive layer once they are electrically charged. When an article touches the touch panel, the intensity of the electrical lines is accordingly changed so that the touch panel can detect where the touch position is.

### BACKGROUND OF THE INVENTION

1. Field of the Invention

The present invention relates to a light transmission touch panel and a manufacturing method thereof, and more particularly, to a touch panel having capacitance circuits and the fabricating method of such a touch panel.

2. Description of the Related Art

When the need for interactive functions grows, a user gradually replaces a mouse or a keyboard with a touch panel. Because the touch panel is a simple, user-friendly and space-saving input apparatus, it is generally applied to a tourist-guiding system, an automatic teller machine (ATM) and a personal assistant pad (PDA), an industrial control system, and so on.

The user just touches a desired sign or a desired item displaced on the screen by a finger so as to operate the computer online connected to the touch panel. As shown in FIG. 1, a touch-control monitor 10 has a transparent touch panel 11 placed on the surface of an electrical screen 12 that shows several items to be selected. When the finger touches the position of one item, a corresponding voltage is induced in response to the coordinates of the touch point. Therefore, a host (not shown) connected with the touch-control monitor 10 can recognize which item is selected and execute the instruction corresponding to the item.

FIG. 2 is a cross-sectional diagram of the touch panel 11 in FIG. 1 along a longitudinal direction. The touch panel 11 comprises a transparent substrate 115 and a lower circuit layer 114 disposed on the upper surface of the transparent substrate 115. The lower circuit layer 114 is a patterned transparent conductive film. Indium-tin oxide (ITO) is preferable for the lower circuit layer 114. Furthermore, a plurality of space dots 113 are discretely overlaid on the lower circuit layer 114, and the distance between two adjacent space dots 113 is the same not only in a longitudinal direction but also in a transverse direction. The outside of the touch panel 11 is covered with a smooth transparent film 111 so that the user just directly touches the smooth transparent film 111. Consequently, the internal electrical structure is protected by the smooth transparent film 111 from damage.

An upper circuit layer 112 similar to the lower circuit layer 114 is disposed on the inner surface of the transparent film 111. The space dots 113 can separate the upper circuit layer 112 from the lower circuit layer 114 when the user does not touch the touch panel 11. An adhesive 116 is dispensed on the perimeter of the touch panel 11 to glue the transparent film 111 and the substrate 115 together. Once the tip of the finger or the sharp portion of an article presses the transparent film 111, the upper circuit layer 112, a flexible plastic film, sags at the touch location till it contacts the lower circuit layer 114.

The aforesaid touch panel 11 is a kind of conventional resistance circuit (or a press-type circuit). That is, the upper circuit layer 112 and the lower circuit layer 114 contact each other due to pressing, and hence the voltage or the circuit of the touch panel 11 correspondingly varies. Consequently, the touch location can be detected. Because the transparent film 111 is a flexible plastic substrate, the wear-resistance, corrosion-resistance and transparency of it are inferior to those of a glass substrate. Accordingly, a non-press-type touch panel with a capacitance circuit structure gradually replaces the press-type touch panel 11. However, there are a plurality of opaque metal cathodes and opaque metal anodes regularly disposed on a plastic substrate to form such a capacitance circuit structure, and hence it is not suitable for the touch-control monitor as an input device. The non-press-type touch panel is limited to have the application of a pointing device for a general computer. Though the non-press-type touch panel is superior to the press-type touch panel in the reliability and sensitivity of operation, it cannot be popularly applied to the other electrical apparatus as an input device.

As a result, there is a need for a touch panel capable of accurately and sensitively sensing a touch. Furthermore, the touch panel has a transparent structure so that it can be popularly applied to all electrical apparatuses as an input device.

### SUMMARY OF THE INVENTION

An objective of the present invention is to provide a light transmission touch panel and a manufacturing method thereof. A transparent conductive material is utilized to be two opposite electrodes of a capacitor. Therefore, the touch panel with such transparent capacitance circuits is applicable to any kind of touch-control monitor for receiving selected instructions.

To achieve the objective, the present invention discloses a light transmission touch panel and a manufacturing method thereof. A touch panel comprises a transparent substrate, a first transparent conductive layer, an insulation layer and a second transparent conductive layer, wherein the first transparent conductive layer, the insulation layer and the second transparent conductive layer are patterned and overlaid on a surface of the substrate. The first transparent conductive layer and the second transparent conductive layer are either on a surface or respectively on two opposite surfaces of the insulation layer. An electrical field having a component along the surface of the substrate occurs between two adjacent portions of the first transparent conductive layer and the second transparent conductive layer once they are electrically charged. When an article touches the touch panel, the intensity of the electrical lines is accordingly changed so that the touch panel can detect where the touch position is.

When the first transparent conductive layer and the second transparent conductive layer are on the same surface of the insulation layer, there is a plurality of through holes provided on the insulation layer. A vertical conductive cylinder is filled in the through hole, and has a first end connected to an electrode plate of the second transparent conductive layer. A plurality of conductive wires are disposed on a surface of the insulation surface opposite the second transparent conductive layer, and each of the conductive wires is connected to the second end of the vertical conductive cylinder.

### BRIEF DESCRIPTION OF THE DRAWINGS

The invention will be described according to the appended drawings in which:

FIG. 1 is a schematic diagram of a conventional touch-control monitor;

FIG. 2 is a cross-sectional diagram of the touch panel in FIG. 1;

FIGS. 3(a)-3(c) are diagrams regarding the manufacturing steps of a light transmission touch panel in accordance with a first embodiment of the present invention;

FIG. 4 is a cross-sectional diagram along line 1-1 in FIG. 3(c);

FIGS. 5(a)-5(c) are diagrams regarding the manufacturing steps of a light transmission touch panel in accordance with a second embodiment of the present invention; and

FIG. 6 is a cross-sectional diagram along line 2-2 in FIG. 5(c).

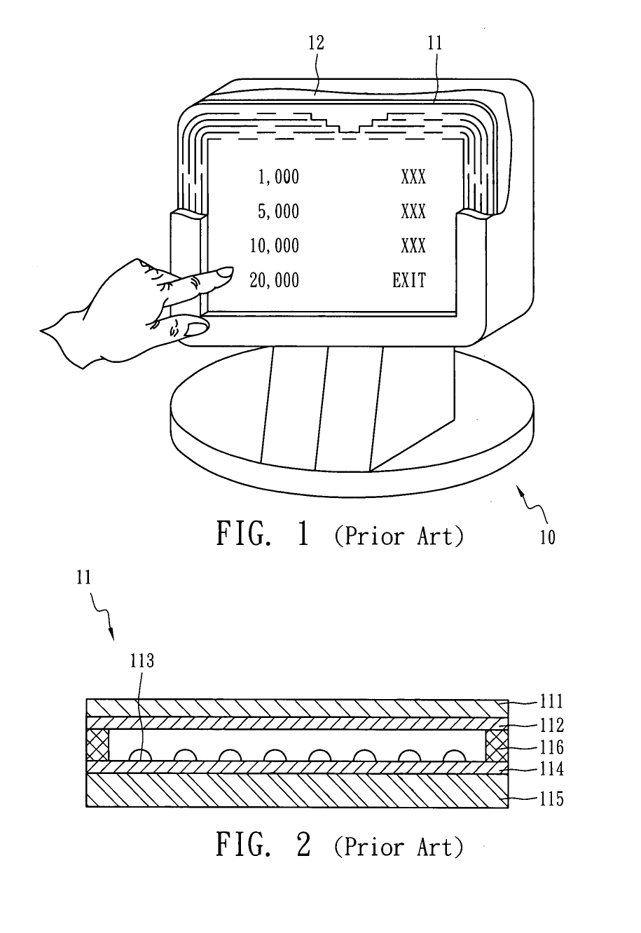

### DETAILED DESCRIPTION OF THE INVENTION

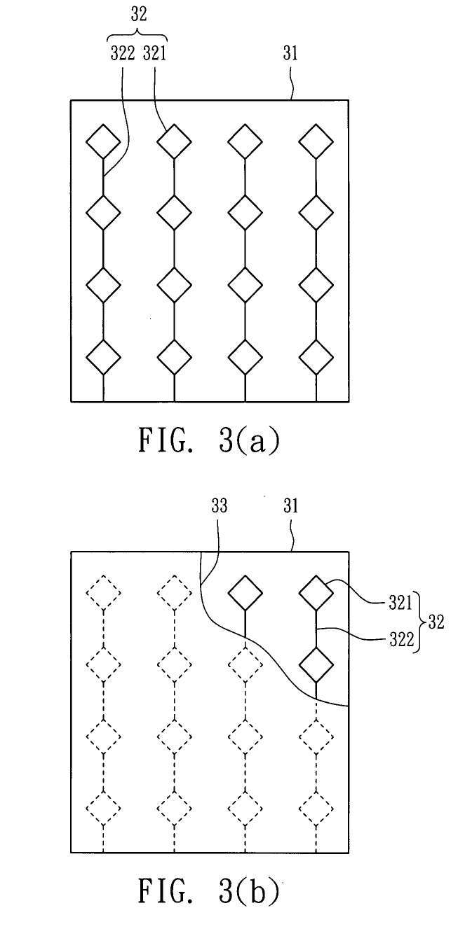

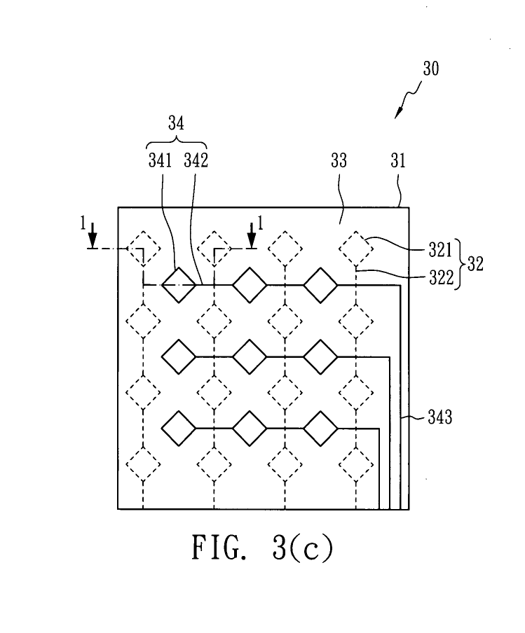

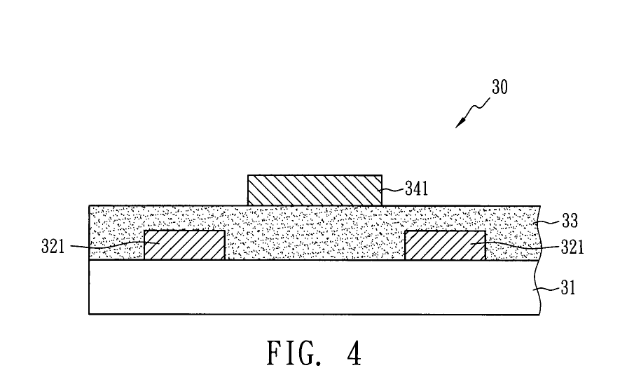

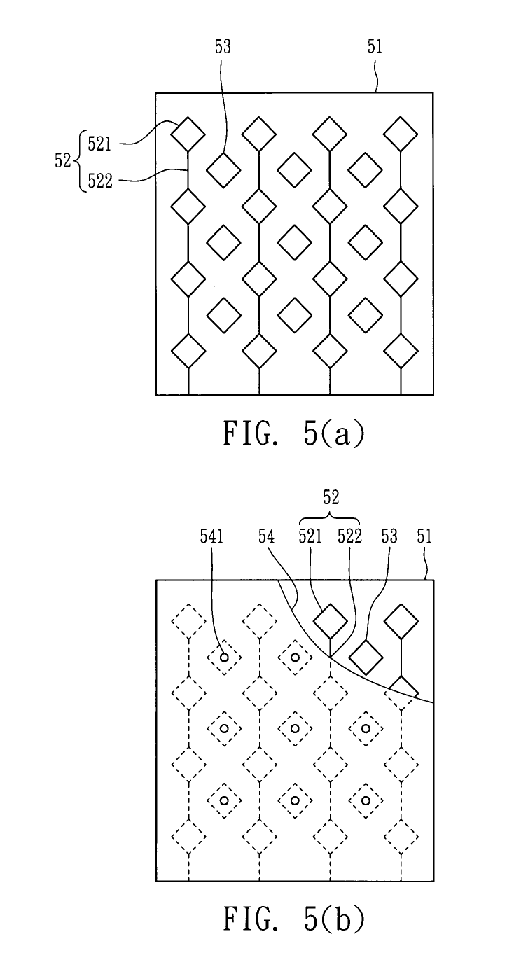

FIGS. 3(a)-3(c) are diagrams regarding the manufacturing steps of a light transmission touch panel 30 in accordance with the present invention. A first transparent conductive layer 32 is patterned and formed on a transparent substrate 31 by a photolithography process, and includes a plurality of first electrode plates 321 and a plurality of first wires 322 longitudinally connecting first electrode plates 321 that are aligned. The transparent substrate 31 is glass or a transparent polymer such as polycarbonate (PC) and polyvinyl chloride (PVC). Furthermore, the first transparent conductive layer 32 is an indium-tin oxide (ITO), aluminum-zinc oxide (AZO) or indium-zinc oxide (IZO). The photolithography process includes sputter, coating, exposure, soft baking, hard baking, development, baking and so on.

As shown in FIG. 3(b), an insulation layer 33 is overlaid on the first transparent conductive layer 32 and the substrate 31, and is a polymer material such as epoxy, polyimide or acrylic. As shown in 3(c), a patterned second transparent conductive layer 34 is overlaid on the insulation layer 33, and comprises a plurality of second electrode plates 341 and a plurality of second wires 342 transversely connecting the second electrode plates 341 that are aligned. Furthermore, there are a plurality of connection wires 343 disposed on a side of the insulation layer 33, whereby each chain of the second electrode plates 34 transversely connected turns toward the bus end of the first leads 322. The shapes of the first electrode plates 342 and second electrode plates 341 are not limited to be a rhombus or a rectangle. Other kinds of shapes may be devised by persons skilled in the art without departing from the concept of the present invention.

FIG. 4 is a cross-sectional diagram along line 1-1 in FIG. 3(c). The first transparent conductive layer 32, the insulation layer 33 and the second transparent conductive layer 34 are overlaid on the transparent substrate 31 by the photolithography process to form the light transmission touch panel 30, and the insulation layer 33 is sandwiched between the first transparent conductive layer 32 and the second transparent conductive layer 34. A lateral electrical field occurs between one of the first electrode plates 342 and one of the second electrode plates 341 adjacent to each other, once they are electrically charged. Consequently, a component of the electrical field is parallel to the surface of the transparent substrate 31. When an article touches the touch panel 30, the intensity of the electrical lines is accordingly changed so that the touch panel 30 can detect where the touch position is.

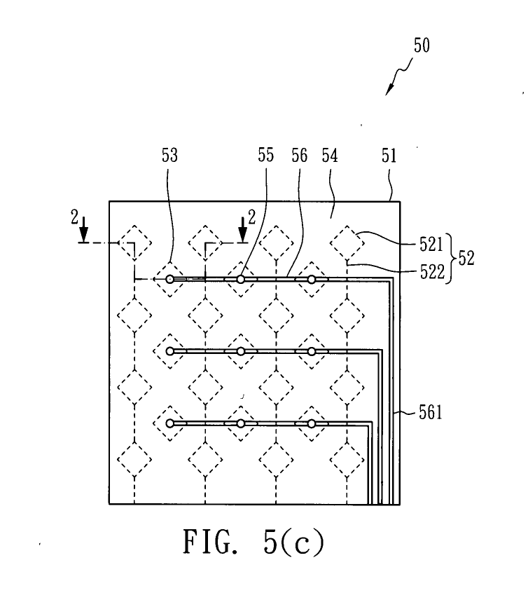

FIGS. 5(a)-5(c) are diagrams regarding the manufacturing steps of a light transmission touch panel in accordance with a second embodiment of the present invention. A first transparent conductive layer 51 and a second transparent conductive layer 52 are patterned and formed on a transparent substrate 51 by a photolithography process, and include a plurality of first electrode plates 521 and a plurality of first wires 522 longitudinally connecting first electrode plates 521 that are aligned. The transparent substrate 31 is glass or a transparent polymer such as polycarbonate (PC) and polyvinyl chloride (PVC). Furthermore, the first transparent conductive layer 32 is an indium-tin oxide (ITO), aluminum-zinc oxide (AZO) or indium-zinc oxide (IZO).

As shown in FIG. 5(b), an insulation layer 53 is overlaid on the first transparent conductive layer 52 and the substrate 51, and is a polymer material such as epoxy, polyimide or acrylic. There are a plurality of through holes 541 provided on the insulation layer 54 and above the electrodes of the second transparent conductive layer 53. As shown in FIG. 5(c), a transparent vertical conductive cylinder 55 is filled in the through hole 541 and has a first end connected to an electrode plate of the second transparent conductive layer 53 so that the electrode plates aligned in a transverse line are electrically dependent. Furthermore, there are a plurality of connection wires 561 disposed on a side of the insulation layer 54, whereby each chain of the electrode plates transversely connected turns toward the bus end of the first wires 522. The shapes of the first electrode plates 541 and the electrode plates of the second transparent conductive layer 53 are not limited to be a rhombus or a rectangle. Other kinds of shapes may be devised by persons skilled in the art without departing from the concept of the present invention.

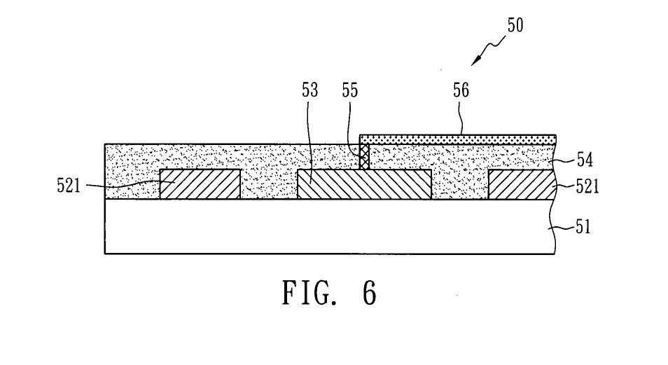

FIG. 6 is a cross-sectional diagram along line 2-2 in FIG. 5(c). The first transparent conductive layer 52, the second transparent conductive layer 53 and the insulation layer 54 are overlaid on the transparent substrate 51 by the photolithography process to form the light transmission touch panel 50, and the insulation layer 54 is sandwiched between the first transparent conductive layer 52 and the second transparent conductive layer 53. A lateral electrical field occurs between one of the first electrode plates 542 and one of the second electrode plates 541 adjacent to each other once they are electrically charged. Consequently, a component of the electrical field is parallel to the surface of the transparent substrate 51. When an article touches the touch panel 50, the intensity of the electrical lines is accordingly changed so that the touch panel 50 can detect where the touch position is.

The above-described embodiments of the present invention are intended to be illustrative only. Numerous alternative embodiments may be devised by persons skilled in the art without departing from the scope of the following claims.

What is claimed is:

1. A light transmission touch panel, comprising:
a transparent substrate;
a first transparent conductive layer patterned and overlaid on a surface of the transparent substrate;
an insulation layer overlaid on the first transparent conductive layer and the transparent substrate; and
a second transparent conductive layer patterned and disposed on the insulation layer.

2. The light transmission touch panel of claim 1, wherein the first transparent conductive layer and the second transparent conductive layer are respectively disposed on opposite surfaces of the insulation layer.

3. The light transmission touch panel of claim 2, wherein the first transparent conductive layer includes a plurality of first electrode plates and a plurality of first wires connecting the first electrode plates aligned in a longitudinal line.

4. The light transmission touch panel of claim 3, wherein the second transparent conductive layer includes a plurality of second electrode plates and a plurality of second wires connecting the second electrode plates aligned in a transverse line.

5. The light transmission touch panel of claim 4, wherein a lateral electrical field occurs between the first electrode plates and second electrode plates adjacent to each other when the first electrode plates and second electrode plates are electrically charged and a component of the electrical field is parallel to the surface of the transparent substrate.

6. The light transmission touch panel of claim 1, wherein the first transparent conductive layer and the second transparent conductive layer are disposed on the same surface of the insulation layer.

7. The light transmission touch panel of claim 6, wherein the first transparent conductive layer includes a plurality of first electrode plates and a plurality of first wires connecting the first electrode plates aligned in a longitudinal line.

8. The light transmission touch panel of claim 7, wherein the second transparent conductive layer includes a plurality of second electrode plates.

9. The light transmission touch panel of claim 8, further comprising a plurality of through holes provided on the insulation layer and a plurality of vertical conductive cylinders filled in the through holes, wherein a first end of the vertical conductive cylinder is connected to one of the second electrode plates.

10. The light transmission touch panel of claim 9, further comprising a plurality of conductive wires disposed on the surface of the insulation surface opposite to the second transparent conductive layer, wherein each of the conductive wires is connected to a second end of at least one of the vertical conductive cylinders.

11. The light transmission touch panel of claim 8, wherein a lateral electrical field occurs between the first electrode plates and second electrode plates adjacent to each other when the first electrode plates and second electrode plates are electrically charged and a component of the electrical field is parallel to the surface of the transparent substrate.

12. The light transmission touch panel of claim 1, wherein the transparent substrate is glass or a transparent polymer.

13. The light transmission touch panel of claim 1, wherein each of the first transparent conductive layer and the second transparent conductive layer includes an indium-tin oxide (ITO), aluminum-zinc oxide (AZO) or indium-zinc oxide (IZO).

14. The light transmission touch panel of claim 9, wherein the insulation layer is a polymer material.

15. A method for manufacturing a light transmission touch panel, comprising the steps of:
providing a transparent substrate;
patterning a first transparent conductive layer overlaid on the transparent substrate by a first photolithography process;
overlaying an insulation layer on the first transparent conductive layer and the transparent substrate; and
patterning a second transparent conductive layer overlaid on the insulation layer by a second photolithography process.

16. The method for manufacturing the light transmission touch panel of claim 15, wherein the transparent substrate is glass or a transparent polymer.

17. The method for manufacturing the light transmission touch panel of claim 15, wherein each of the first transparent conductive layer and the second transparent conductive layer includes an indium-tin oxide, aluminum-zinc oxide or indium-zinc oxide.

18. The method for manufacturing the light transmission touch panel of claim 15, wherein the insulation layer is a polymer material.

19. The method for manufacturing the light transmission touch panel of claim 15, wherein the first photolithography process and the second photolithography process include a step of sputtering, coating, exposure, soft baking, hard baking and development.

20. A method for manufacturing a light transmission touch panel, comprising the steps of:
providing a transparent substrate;
patterning a first transparent conductive layer and a second transparent conductive layer overlaid on the transparent substrate by a first photolithography process;
overlaying an insulation layer on the first transparent conductive layer, the second transparent conductive layer and the transparent substrate;
forming a plurality of vertical conductive cylinders through the insulation layer, wherein a first end of the vertical conductive cylinder is connected to the second transparent conductive layer; and
disposing a plurality of conductive wires on a surface of the insulation surface opposite to the second transparent conductive layer, wherein each of the conductive wires is connected to a second end of the vertical conductive cylinder.

21. The method for manufacturing the light transmission touch panel of claim 20, wherein the transparent substrate is glass or a transparent polymer.

22. The method for manufacturing the light transmission touch panel of claim 20, wherein each of the first transparent conductive layer and the second transparent conductive layer includes an indium-tin oxide, aluminum-zinc oxide or indium-zinc oxide.

23. The method for manufacturing the light transmission touch panel of claim 20, wherein the insulation layer is a polymer material.

24. The method for manufacturing the light transmission touch panel of claim 20, wherein the first photolithography process and the second photolithography process includes a step of sputtering, coating, exposure, soft baking, hard baking and development.
